(19) United States
(12) Patent Application Publication
(10) Pub. No.: US 2002/0112141 A1
(43) Pub. Date: Aug. 15, 2002

(54) Time division finite state machine

(76) Inventors: Claire Greenwood, Newtownabbey (GB); Mark Carson, Belfast (GB); Andrew Brown, Carrickfergus (GB)

Correspondence Address: William M. Lee, Jr., LEE, MANN, SMITH, MCWILLIAMS,, SWEENEY & OHLSON, P.O. Box 2786, Chicago, IL, 60690-2786, US

(21) Appl. No.: 10/041,418

(22) Filed: Jan. 8, 2002

Related U.S. Application Data
(60) Provisional application No. 60/260,336, filed on Jan. 8, 2001.

(51) Int. Cl. G06F 15/00

(52) U.S. Cl. 712/1

(57) ABSTRACT

A combinatorial processor capable of processing a plurality of groups of informational elements is provided in which each group has at least one distinguishing characteristic. The combinatorial processor comprises a time-division multiplexed combinatorial logic element; and a plurality of storage elements. Each storage element is associated with one of the plurality of groups, and within a time-slot of the time-division multiplexed combinatorial logic element a storage element stores state information in accordance with information processed from one of the informational elements of the group associated with that storage element. The invention thus enables read state information for an informational element currently being processed to be replaced with the write state information from a previous informational element in the case where two informational elements belonging to the same group are adjacent to each other in the sequence.

### BACKGROUND TO THE INVENTION

This invention relates to time division mutiplexed combinatorial logic and to a finite state machine having time division multiplexed combinatorial logic. The invention enables multiple identical finite state machines to be replaced by a single implementation which efficiently re-uses combinational logic by time division multiplexing and avoids the need for memory sub-systems which can degrade performance. This reduces the amount of logic required for implementation.

A conventional Moore or Mealy style finite state machine is a computational mechanism with a finite number of well defined states. Inputs to the state machine can cause the state to change. In a Moore state machine the outputs depend on only the current state of the state machine and in a Mealy state machine the outputs depend on the current state and the current inputs to the state machine. A counter is an example of a basic state machine.

Referring now to FIG. 1 of the accompanying drawings, a conventional Moore state machine 100 representing a counter is illustrated in which only 5 possible states are available—the states 101a, 101b, 101c, 101d, 101e, which are used to represent the numbers 0, 1, 2, 3 and 4 respectively. From each state the state machine can be reset to the initial state 101a or incremented to the next state. In the absence of an explicit reset or increment event the state machine retains its current state. The state machine 100 thus changes state whenever either a reset or an increment occurs. A reset changes the state to the initial state 101a irrespective of the current state of the state machine. An increment changes the state to another state depending on the current state. The current state is therefore used to determine the next state depending on the inputs.

FIG. 2 sketches an example of an implementation 102 for a state machine such as state machine 100 shown in FIG. 1. The implementation 102 includes combinational logic 104 and a storage element 106 to maintain the state 101 of the state machine 100. The combinatorial logic 104 is capable of operating on the state machine input 105 in accordance with the current state 108 of the state machine 100 and generates the next state 112. The output from the state machine 110 is taken as a combinational function of the current state using combinational logic 114. The state machine 100 is set to the next state 112 which has been determined by the output of the combinatorial logic 104. The current state 108 of the state machine is maintained by the storage element 100.

Many practical applications require multiple instances of identical state machines. This may be the case if for example an information stream is comprised of recurring interleaved related information.

FIGS. 3A to 3C show information streams consisting of three groups of information labelled A, B and C which are interleaved with each other in either a random or predetermined pattern. Each information group, A, B, and C contains information which is logically related to all other information within that group and independent of any information contained within other groups. For example, information labelled A is related logically to all other information labelled A, and is not logically related to information labelled B or C. In FIG. 3a, the information stream of related information groups is interleaved in a predetermined fixed pattern. FIG. 3B and 3C each show an information stream of related information groups in which the different information groups are interleaved in a random or unknown pattern.

If, for example, the amount of information in the group labelled A is required, a counter can be used to count only the information labelled A, similarly for B and C. Therefore to obtain the amount of information in the information groups labelled as A, B and C three counters are required, i.e. three state machines. Each state machine is identical and therefore for this application, multiple instances of identical state machines are required. When the state machine required to count information in group A is in use, the other two state machines are idle, and therefore the use of logic is inefficient.

While the state machines are identical, the exterior logic connected as inputs to the state machines is not. This is necessary so as to provide the correct control signals to each individual state machine at the correct instant For example, the state machine being used to count the information in information group A should perform an increment when the information currently being analysed belongs to information group A. The logic to determine this is unique to state machine A and exterior to it.

One example of a practical application which requires multiple instances of identical state machines exists within a Synchronous Digital Hierarchy (SDH) network (or equivalently within a Synchronous Optical Network (SONET)).

FIG. 4 shows schematically a high order VC-4 virtual container within which a plurality of lower order data streams, for example three TU-3s, are byte interleaved to form an STM-1 frame. Each TU-3 consists of related information which is interleaved to form an information stream of recurring related interleaved information.

To facilitate the individual processing of TU-3 information, a plurality of state machines are usually employed, one state machine corresponding to each TU-3. For example, if the number of bytes per TU-3 shown in FIG. 4 is required, three byte counters may be implemented, such as FIG. 5 illustrates. This provides a typical example of multiple instances of identical state machines.

In FIG. 5, the TU-3 decoding logic shown is used to determine which of the three possible TU-3's is currently being processed and activate the corresponding state machine. This logic is external to the individual state machines.

In the case where only three state machines are provided, only one of which can be operable at any time, the redundancy is not large. In other embodiments, for example where a higher order virtual container contains a high number of lower order data streams, the number of identical state machines is correspondingly increased. For example, in the case where a VC-4 contains 63 TU-12s, 63 identical state machines are required. At most 1 of the 63 identical state machines can be active at any instant, the rest remaining inactive and therefore the logic is inefficient. As the number of different state machines increases for each TU-12, the number of identical state machines required increases by 63. This takes up a considerable amount of combinational logic, and when space is at a premium, reduction of the amount of combinational logic is desirable. Instantiation of multiple identical state machines on silicon becomes impractical as the number of identical state machines required increases, the amount of area consumed rises and can cause layout problems which may result in increasing the die size of the silicon which in turn increases the cost.

Referring now to FIG. 6 of the accompanying drawings, a known finite state machine 200 is shown U.S. Pat. No. 4,852,157 in which the state machine logic 202 consists of combinatorial logic 204 and storage elements 206 which are provided to form an interface to the external memory sub-system, and maintain the current state of the currently active state machine. The combinatorial logic 204 is capable of determining which of a plurality of state machines (for equivalents see FIG. 5 for example) should currently be operating (the decode logic), and is capable of determining the next state from the current state and the current inputs 203 of the state machine, and controlling the exterior memory sub-system 216 to provide storage of the current state for the relevant state machine instance. The current state of each of the plurality of state machines is therefore maintained within the exterior memory sub-system 216. Suitable memory access control means and storage elements 206 are included within the state machine logic and regulate access to the memory sub-system 216 to ensure that each current state stored is read from the correct memory address and each next state generated by the combinatorial logic is written to the correct address. The storage element 214 is here part of an exterior memory sub-system 216. Further output 218 is also generated.

By time division multiplexing the combinatorial logic 204 of the finite state machine implementation illustrated in FIG. 6, a single finite state machine can replace a plurality of finite state machines configured to have identical functions. For example, the three state machines of FIG. 5 can be replaced by a single state machine implementation. This requires the combinatorial logic 204 to be time division multiplexed with a storage element 206 used to store the state 201 for each of the state machines illustrated in FIG. 5 and is possible because at most, one identical state machine such as FIG. 5 illustrates is functioning at any one time.

The state machine illustrated in FIG. 6 involves the re-use of common combinatorial logic in a manner which necessitates the redesign of conventional finite state machines. This is disadvantageous and limits the cost-effectiveness of such an implementation of a time-division multiplexed combinatorial logic finite state machine. In FIG. 6, the combinational logic processor 202 consists of combinatorial logic 204 which uses storage elements 206 to access a memory sub-system 216. The combinatorial logic process 202 obtains information from input 203 and is designed separately from the memory sub-system 216 which holds the storage elements used to store the multi-instance information (the various states of each separate group of informational elements. The memory sub-system 216 is used to control memory access to each “virtual” state machine memory 214. The combinational processor 220 must request information from memory 214 via the storage element 206 and using the suitable memory access control means, and in some cases may need to stall the combinatorial process until memory access is complete. This stalling process is not desirable and is disadvantageous as delay in writing and accessing the states of the virtual multi-instance finite state machine stored in the memory sub-system degrades the performance of the multi-instance finite state machine.

### SUMMARY OF THE INVENTION

The present invention seeks to obviate and/or mitigate the disadvantages described above in which identical state machines having essentially duplicate functions are implemented.

An object of the invention seeks to provide a combinatorial processor having time-division multiplexed combinatorial logic.

Another object of the invention seeks to provide a method of processing a plurality of groups of informational elements using time-division multiplexed combinatorial logic.

Yet another object of the invention seeks to provide a time-division multiplexed finite state machine.

Yet another object of the invention seeks to provide apparatus for a communications network having a time-division multiplexed finite state machine.

Yet another object of the invention seeks to provide a method of extracting state information from a storage element maintaining the state of a plurality of time-division multiplexed data streams.

Yet another object of the invention seeks to provide a method of pointer processing using a combinatorial processor having time-division multiplexed combinatorial logic.

Yet another object of the invention seeks to provide a method of path overhead processing using a combinatorial processor having time-division multiplexed combinatorial logic.

Yet another object of the invention seeks to provide a clocking function for generating state information on an informational element in a sequence of interleaved groups of informational elements.

A first aspect of the invention seeks to provide a combinatorial processor capable of processing a plurality of groups of informational elements, each group having at least one distinguishing characteristic, the combinatorial processor having:

a time-dimension multiplexed combinatorial logic element; and

a plurality of storage elements, wherein

each storage element is associated with one of the plurality of groups, and wherein within a time-slot of the time-division multiplexed combinatorial logic element, a storage element stores state information in accordance with information processed from one of the informational elements of the group associated with that storage element.

Advantageously, each storage element can store the state of the informational group. Each storage element thus acts as a virtual finite state machine.

Preferably, the combinatorial logic generates the read address for the state information, from which the write address is also generated using delay element.

Advantageously, the combinatorial logic generates read and write addresses for the state information generated which mitigates and/or obviates any stalling of the combinatorial logic process.

The read address for the state information may comprise a write address generated using delay elements, wherein state information generated by the processing of a previous informational element is held at the write address.

Preferably, the combinatorial processor is able to function as a plurality of finite state machines by duplicating state storage functions internally.

Preferably, the storage elements comprise a register file.

Alternatively, the storage elements comprise Random Access Memory.

Preferably, the combinatorial processor determines the next state of any one of the plurality of groups of informational elements in accordance with the current state and any input received.

Preferably, the informational elements of each group are interleaved. Preferably, the interleaved sequence of informational elements is read in sequence.

The informational elements of each group may be bit interleaved.

The time-slots of the time-division multiplexing process may be of fixed length. Alternatively, the time-slots of the time-division multiplexing process may be of variable length.

A preferred embodiment of the invention provides a combinatorial processor capable of processing a plurality of groups of informational elements, each group having at least one distinguishing characteristic, the combinatorial processor having.

a time-division multiplexed combinatorial logic element; and

a plurality of storage elements, wherein

each storage element is associated with one of the plurality of groups, and wherein within a time-slot of the time-division multiplexed combinatorial logic element, a storage element stores state information in accordance with information processed from one of the informational elements of the group associated with that storage element, wherein the write address of previously generated state information is used as the read address for state information to be processed by a subsequently input informational element by using a delay element, in the event that the previously generated state information was generated by an informational element belonging to the same group as the subsequently input informational element.

Preferably, the distinguishing characteristic for each group is the address of the storage element in which the state information to be combined with each informational element is stored at.

A second aspect of the invention seeks to provide a method of processing a plurality of groups of informational elements, each group having at least one distinguishing characteristic, the method comprising:

receiving an informational element;

extracting information from the informational element and determining state information in accordance with the extracted information using a time-division multiplexed combinatorial logic element;

selecting a storage element in accordance eith the group of the informational element; and

storing the said state information in the storage element.

Preferably, said step of storing the said state information comprises the steps of:

creating a write address for storing the written state information, the write address corresponding to a read address for a state information of a subsequent informational element by using a delay element in the case where the two informational elements belong to the same group and are adjacent to each other in the sequence.

Preferably, the delay element 310 comprises flip-flop or equivalent device, and can be implemented separately or form part of the storage element device.

Preferably the informational elements are interleaved to from a sequence having a regular pattern.

Alternatively, the informational elements may be interleaved to form a sequence having a random pattern.

A third aspect of the invention seeks to provide a time-division multiplexed finite state machine having a combinatorial processor according to a first aspect of the invention.

A fourth aspect of the invention seeks to provide a time-division multiplexed finite state machine according to the third aspect of the invention, wherein the finite state machine is used to determine information on a plurality of lower order data streams within a higher order virtual container.

Preferably, the finite state machine is a counter-like machine for counting at least one characteristic of the informational elements.

Alternatively, the finite state machine may be used to identify any of a number of characteristics relating to the information elements within an information group or a subset thereof.

A fifth aspect of the invention seeks to provide apparatus for a communications network having a time-division multiplexed finite state machine according to the fourth aspect of the invention.

A sixth aspect of the invention seeks to provide a method of extracting state information from a storage element maintaining the state of a plurality of time-division multiplexed data streams, wherein each data stream comprises a group of informational elements, each data stream having at least one distinguishing characteristic, the method comprising:

receiving an informational element;

extracting information from the informational element and determining state information in accordance with the extracted information using a time-division multiplexed logic element;

selecting a storage element in accordance with the data stream of the informational element; and

storing the said state information in the storage element.

A seventh aspect of the invention seeks to provide a method of pointer processing using a combinatorial processor according to the first aspect of the invention and employing a method according to a second aspect of the invention.

An eighth aspect of the invention seeks to provide a method of path overhead processing using a combinatorial processor according to a first aspect of the invention, and employing a method according to a second aspect of the invention.

A ninth aspect of the invention seeks to provide a clocking function for generating state information on an informational element in a sequence of interleaved groups of informational elements, each group of informational elements having at least one distinguishing characteristic, wherein the clocking function is provided to replace the read state information for the current element with the write state information from the previous element in the case where two informational elements belonging to the same group are adjacent to each other in the sequence.

Preferably, the clocking function is implemented by a combinatorial processor according to a first aspect of the invention.

Preferably, the distinguishing characteristic for each group is the address of the storage element in which the state information to be combined with each informational element is stored at.

Advantageously, the invention does not require any additional memory control, and enables data in adjacent time-slots to be accessed without incurring undue delay such as the prior art provides.

Advantageously, the above aspects of the invention therefore saves design time, simplifies testing, is more efficient in the use of logic, decreases silicon area and helps reduce silicon cost than conventional technology and techniques which duplicate the number of finite state machines.

Advantageously, by implementing storage elements which represent each virtual finite sate machine which are under the control of the combinatorial processor, information which is determined from sequential informational elements belonging to the same group can be stored without additional delay by overwriting the read address memory of a previous state with the write address of the current state. Informational elements belonging to the same group which are adjacent to each other in a stream of interleaving informational elements can thus be stored without stalling the execution of the combinatorial logic.

Advantageously, the combinatorial logic processor having time-division multiplexed combinatorial logic may be implemented in software. The implementation may also be implemented solely in hardware. Alternatively, a combination of software and hardware may be used to create a physical device incorporating the combinatorial logic processor within apparatus for use in a communications network, for example, in a data and/or tele-communications network.

All of the above preferred features and preferred features as defined by the dependent claims filed herewith and relevant advantages may be appropriately combined with each other and with each of the given aspects of the invention as is apparent to those skilled in the art.

### BRIEF DESCRIPTION OF THE DRAWINGS

There follows a description of the invention with reference to the accompanying drawings which are by way of example only and in which:

FIG. 1 shows states in a finite state machine;

FIG. 2 shows a conventional state machine implementation;

FIG. 3 shows interleaved related data structures;

FIG. 4 shows a schematic view of a STM-1 frame;

FIG. 5 shows conventional multiple identical state machines;

FIG. 6 shows a state machine implementation using a separate memory sub-system;

FIGS. 7A, 7B, and 7C show a multi-instance finite state machine according to the invention;

FIGS. 8A and 8B show examples of clocking functions for the finite state machines of FIGS. 7A, 7B and 7C; and

FIG. 9 shows steps in a method of providing state information according to the invention.

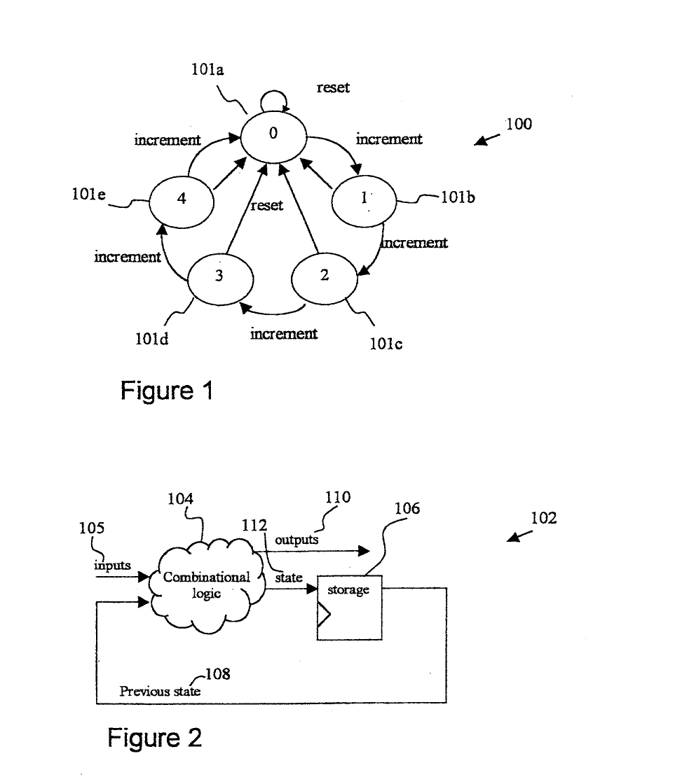

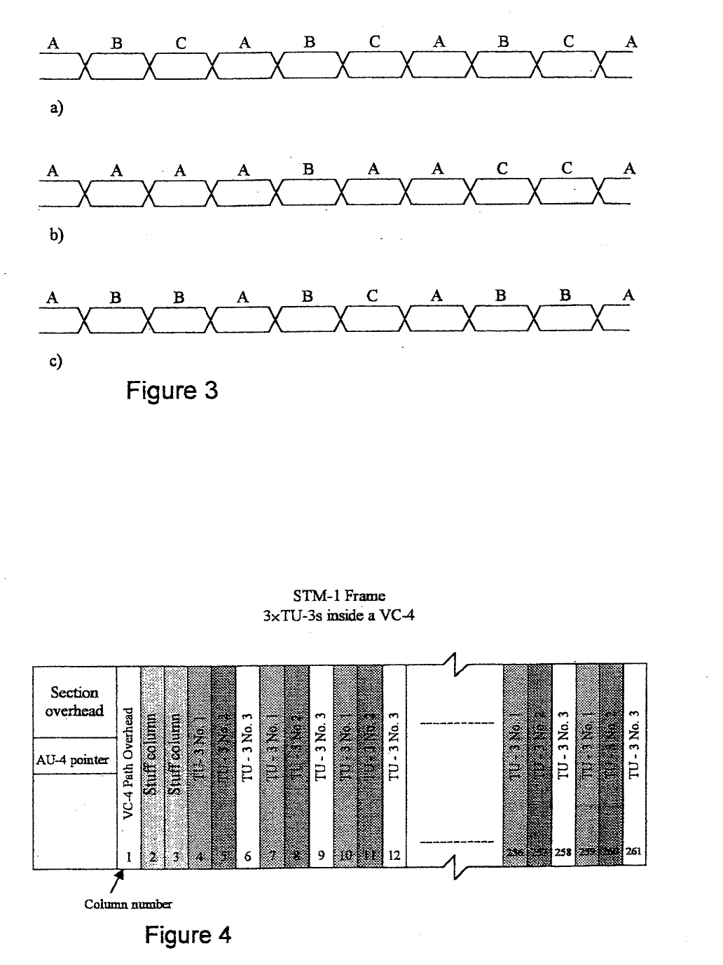

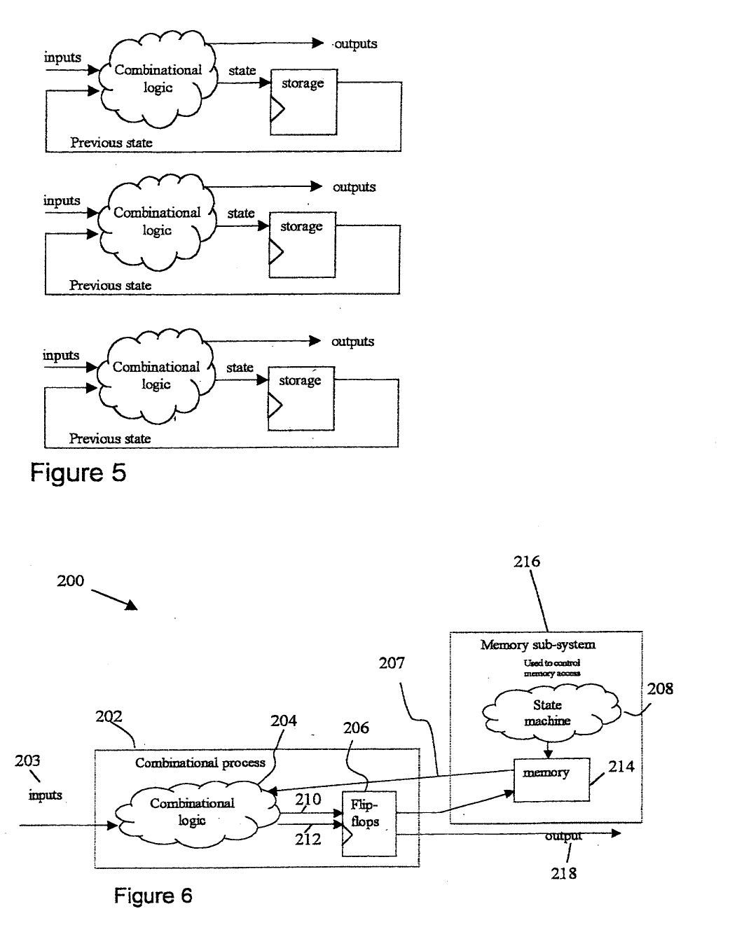

### DETAILED DESCRIPTION OF PREFERRED EMBODIMENTS

The best mode of the invention as contemplated by the inventors is now described with reference to the accompanying drawings.

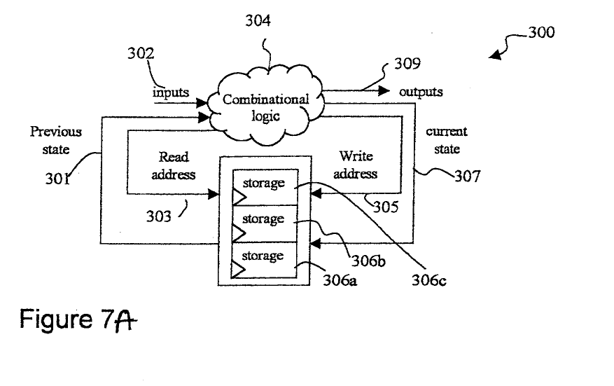

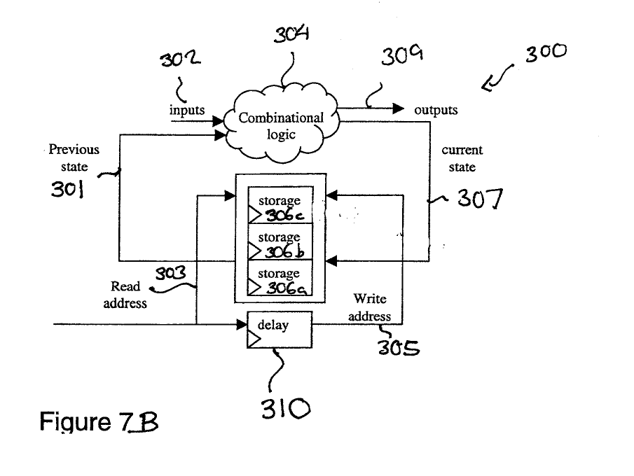

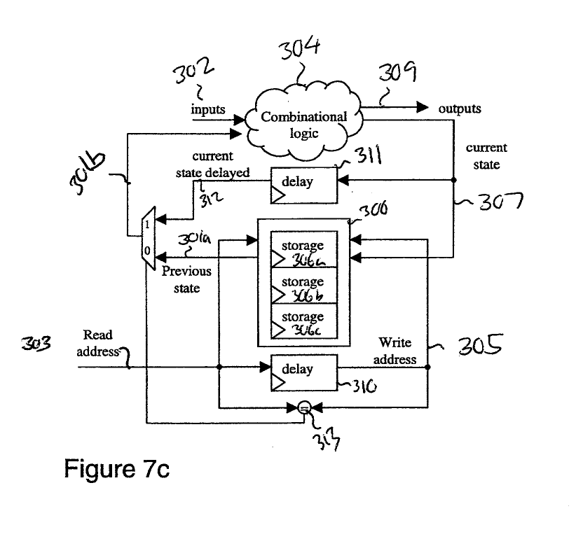

Referring now to the accompanying drawings, FIGS. 7A, 7B, and 7C illustrate a multi-instance finite state machine 300 which represent the best modes of the invention contemplated by the inventors. The finite state machine 300 receives as input a sequence of interleaved groups of informational elements. Each group consists of informational elements which are related to each other and which can be distinguished from the other group(s) in the sequence. An example is the three TU-3 data streams which are bit-interleaved into an VC-4 virtual container such as is shown in FIG. 4. Other examples include any time-division multiplexed sequence of informational elements, for example, interleaved sequence of data streams such as occur when lower order virtual containers are time-division multiplexed into higher order virtual containers.

The multi-instance finite state machine 300 comprises a combinatorial logic processor having combinatorial logic 304 and a memory 306 (for example, register list or RAM). A conventional design flow is adopted, therefore saving design time and simplifying design and testing.

The combinatorial logic 304 receives as input 302 a sequence of informational elements forming distinct groups of information and information on a previous state 301. Extracting a particular group of informational elements requires selectively extracting those informational elements from the data stream. For each distinct group of informational elements, the combinatorial logic processor determines the current state by determining the state information using the currently input informational element and the previous state information 301 stored for that group. Each group thus corresponds to informational elements which operate on a state information stored at a specific storage element address in the storage element array 306.

The combinatorial logic processor 304 thus provides direct access to a number of virtual finite state machines. Each virtual finite state machine is arranged to provide state information for a different group of informational elements within the sequence of information which is input into the combinatorial logic processor. For example, corresponding to the three TU-3 streams shown in FIG. 4, three virtual state machines may be incorporated into the combinatorial logic processor to store state information on each TU-3 stream. In the embodiment illustrated in FIGS. 7A, 7B, 7C, therefore, three states 301a, 301b, 301c are stored within the combinatorial processor in storage elements 306a, 306b, 306c respectively. Each virtual finite state machine is able to act as a counter for one of the three TU-3 data streams, without the duplication of combinatorial logic otherwise required if three identical finite state machines were implemented.

Advantageously, as FIG. 7A shows, the combinatorial logic 304 processes inputs 302 and the previous state information 301 to generate current state information 307. The combinatorial logic 304 can process state information 301 provided by one of two sources. Either previous state information 301 may be extracted from the read address for a particular storage element corresponding to the group of the inputted informational element, or, in the event that the previously inputted informational element belonged to the same group as the currently input informational element, the state information retrieved using the read address is replaced with the write state information which is to be stored at the write address. In this way, it is possible to ensure that the state information generated has been properly updated.

To enable this, the invention advantageously enables the write address of the previous informational element to be derived from the read address of the currently input informational element. This enables the read state information for the current information element to be replaced with the write state information from the previous element in the case where two informational elements belonging to the same group are adjacent to each other in the sequence. The write state information effectively bypasses its initially designated storage element to enable it to form the read state information required by the next information element.

Whilst it be apparent to those skilled in the art that it is not necessary for the informational elements to be adjacent to each other, providing a “cut-thru” mechanism for informational elements separated by two, three, or more clock cycles which belong to the same group, increases the complexity of the invention. Whereas if the informational elements are adjacent, a delay of only one clock cycle in incurred by the process enabling the write address of the first informational element to form the read address of the second informational element, should the informational elements not be adjacent, longer delays are required, and the storage, bypass and cut-thru processes become more complex as a result.

In some embodiments of the invention, further output 309 is generated. The combinatorial logic processor then writes the state information 307 to the appropriate storage element 306a, 306b, 306c in accordance with the group to which the processed informational element belongs. Each storage element is accessed directly by the combinatorial logic determining appropriate read/write addresses.

The read address which the combinatorial logic uses to extract the state information to be combined with an informational element inputted into the combinatorial logic does not necessarily need to be generated by the combinatorial logic element itself. Instead, as FIG. 7B shows, it may be provided as a direct input to the storage array In FIG. 7B, the read address 303 for a specific state information is generated by some appropriate means and is provided directly to the storage array 306 and/or to the delay element 310 in the case where it is used to provide the write address.

The essential requirement is that for a synchronous system of the type relevant to the invention is that the read address must be provided zero or more clock cycles ahead of the data to which it relates. The exact number of cycles is defined by the read latency of the memory device used to hold the state information. For the embodiments shown in FIGS. 7A, 7B, 7C, 8A, 8B and 9, this latency is assumed to be 1 cycle.

The write address into which updated state information is stored is therefore a delayed version of the read address used to provide state information to the next informational element. This is because the operation of the design relies on reading the information (state), modifying it, and writing it back to the same location. The delay is necessary because it takes a period of time to read the information from the memory (the read latency above), and a further period of time to process the state change in the combinational logic. This second period would normally be a single cycle, but could theoretically be more. In the embodiments discussed herein, it is assumed this is one cycle.

Only once the delay has been allowed for that the state information will be ready to be written back to the RAM. Hence the write address must be a delayed version of the read address. The length of the delay being 1 or more cycles.

Thus in FIG. 7A, the write address 305 is the address state information is output to by processing the informational element. The write address 305 is derived from the read address, and is in fact a delayed version of the read address 303 which has been generated by the combinatorial logic. In FIGS. 7A, 7B, and 7C, therefore, write address is always an unmodified, but delayed, version of the read address.

FIGS. 7B and 7C show more clearly how the road address 303 is can be used to derive the write address 307. FIG. 7C is more complicated in that it shows also the bypass mechanism 311 for the current state information, as well as the delay element 310 used to derive the write address from the read address. In FIG. 7C, informational elements 302 are input into combinatorial logic element 304 and combined with previous state information 301b to generate current state information 307. The previous state information 301b comprises either a delayed version of the current state information 307 provide via a cut-thru mechanism comprising bypass means and a delay element 311 or, previous state information 301a derived from the storage array 306. The bypass means provided comprises the data path taking current state information 307 across into the previous state information 301. The bypass means may thus comprise a stand-alone element or form part of the storage array 306s.

In FIG. 7C, the current read address 303 is compared with the read address of the previously processed informational element, and if the two are the same, the read state information retrieved from the read address is replaced with the write state information generated from the combinational process delayed 312 via delay element 311. If the two addresses are not the same, then read state information is extracted from the storage elements in the usual manner 301 a using the read address.

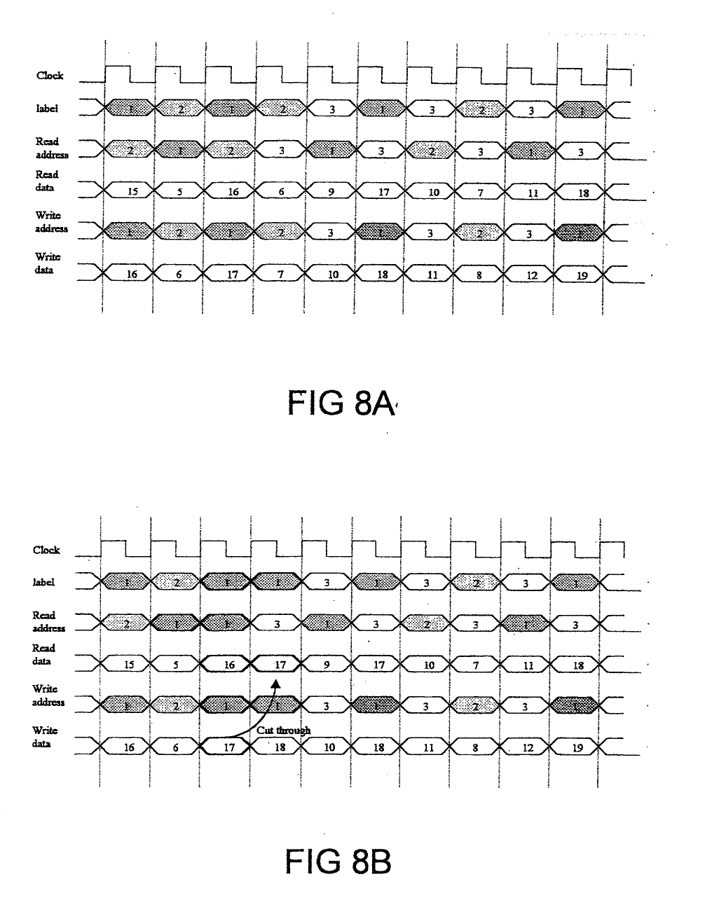

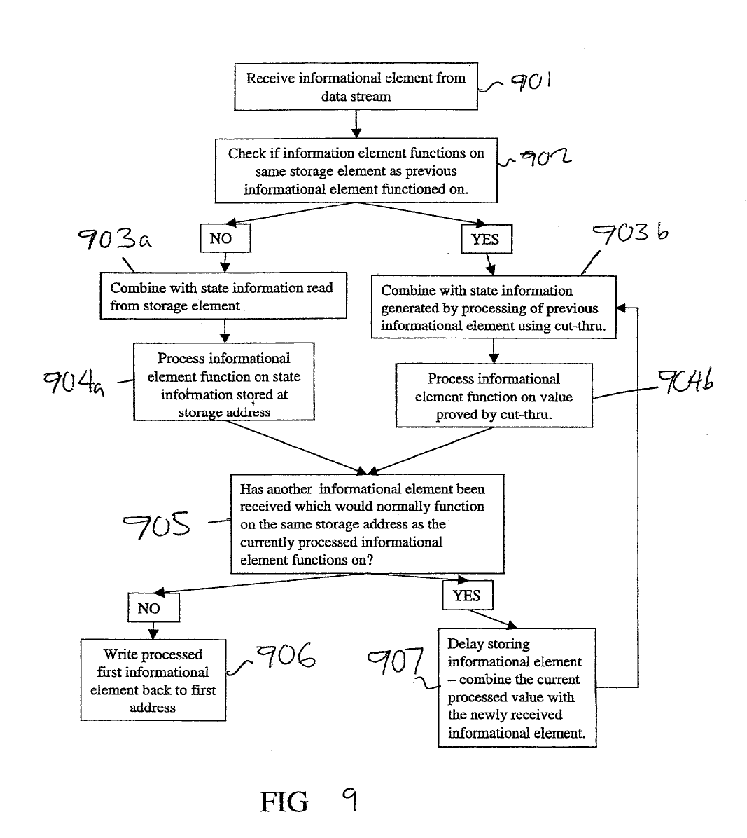

FIGS. 8A and 8B illustrate the clocking function of the invention according to FIGS. 7A to C. The read address of the data is required to be at least one clock cycle ahead of the write address of the data so that the data can be extracted from RAM at the correct time.

In FIG. 8A, three groups of differing informational elements are interleaved. The top sequence in FIG. 8A illustrates the clocking function, the next sequence illustrates the label sequence of each group. The read address indicated by the next sequence is always one cycle ahead of the write sequence, which is shown in the second sequence from the bottom. The read data is shown in the third sequence from the bottom. The bottom sequence represents the write data for the informational groups which is stored in memory.

In the case where information with the same label occurs twice in sequence, then a cut through technique is implemented to enable the read data to be overwritten with write data. This enables the updated information to be used. FIG. 8B shows the label 1 twice in successive time slots when the 2^{nd} read data is overwritten with data just written into the RAM. Accordingly the 2^{nd} read data which is 16 in FIG. 8B is overwritten with the data just written into RAM 17, which ensures that the updated information can be used.

Stalling the combinational process to stall pending memory access to a separate memory sub-system such as the embodiment of FIG. 6 required is therefore reduced and/or avoided. Moreover, the same combinatorial logic 304 can be re-used for each state machine thus reducing the size of the logic required considerably. The combinatorial logic is utilised more efficiently, particularly by implementing two-port RAM or register-files instead of flip-flops, which further decreases the size of the logic.

The time division multiplexed combinatorial logic of the invention can be implemented in a wide variety of applications, in particular in pointer processing and path overhead processing of SDH/SONET payloads. The data may be arranged in fixed length or variable length time slots.

Numerous modifications and variations to the features described above in the specific embodiments of the invention will be apparent to a person skilled in the art. Moreover, well known methods and structures have not been described in detail so as not to unnecessarily obscure the present invention.

For example, in a path overhead processing application, each path overhead byte can be determined using time division multiplexed combinatorial logic according to the invention. This enables, for example, in a Bit Interleaved Parity calculation in path overhead bytes B3NS in an STM-Frame for bits to be XORed with the previous result in RAM.

Similarly, in persistence checking applications, the path overhead byte can be compared to the stored path overhead byte from the last frame and the result stored again in RAM. More generally, any pointer processing application in which the state of the pointer needs to be stored in RAM can be implemented using time-division multiplexed combinatorial processor according to the invention. This enables a consequent action to take place without additional delay, for example, if the pointer is an alarm signal indication (AIS), then each byte of the payload associated with the pointer must be AISed, i.e. the AIS state must be stored, so that each byte of the payload can be overwritten with AIS.

The time-division multiplexed combinatorial logic may be implemented using software, for example, a computer program. The invention may be further incorporated with hardware to provide a physical device for use in a communications network.

Another embodiment of the invention comprises a method of updating state information in a memory array (i.e. an array of storage elements) using a single combinatorial logic element. Conventionally, each storage address in the memory array would require a combinatorial logic element, and so advantageously, the invention reduces the number of combinatorial logic elements which conventional finite state machines require. As is obvious to one skilled in the art, it is possible to have more than a single logic element per array, however, increasing the number of logic elements increases the cost of the finite state machine, and so it is advantageous to reduce the number of combinatorial logic elements to the lowest possible.

Each storage element in the array can be used to store state information which is updated by instructions derived from an incoming data stream. The incoming data stream consists of informational elements, each informational element belonging to a group, where each group corresponds to a specific storage element.

Turning now to FIG. 9 of the accompanying drawings, steps in a method of providing an informational element are shown according to the invention. An informational element here comprises a function operating on state information stored at a specified storage address. The invention enables the combinatorial logic of a finite state machine to provide the currently input informational element with valid state information even in the event that a previous informational element's output has not updated the state information stored at the address that the currently input informational element operates on.

In FIG. 9, an informational element is received from a data stream (step 901) and is combined with current state information (steps 903a or 903b). A check is performed (step 902) to determine it the received informational element is operating on the same storage address as the previous informational element operated on. This check may be performed by the combinatorial logic element and/or the storage element and/or other suitable means.

In the best mode currently contemplated, if the current informational element and previous informational element do not operate on the same storage address, i.e., if they do not belong to the same group, then the current informational element operates on the state information read from the storage address for that type of informational element (step 903a).

However, if the current informational element and the previous informational element do operate on state information stored at the same storage address, the invention provides a “cut-thru” technique (described in more detail herein below) to ensure that the combinatorial logic combines the current informational element with the state information output by the processing of the previous informational element (step 903b). This cut-thru mechanism enables the combinatorial logic to provide the currently input informational element with the state information currently held at the address which was written to by the combinatorial logic processing the previous informational element. Thus the state information retrieved from the storage element using the read address for the informational element to operate on is replaced by the the state information generated using the previous informational element.

The newly generate output can then checked to determine if the cut-thru technique is to be used to provide the next informational element input to the combinatorial logic with the processed state information output by the currently processed informational element. (This step, 905, may be combined with the step of checking the informational element received 902).

If the next informational element does not belong to the same group as the current informational element, the state information output by the currently processed informational element is written back to the storage address for that group (step 906). If the next informational element does belong to the same group, then the storage of the update state information is delayed (step 907) and the updated information is instead diverted (using the cut-thru mechanism) and is combined with the next informational element by the combinatorial logic (return to step 903b).

After being used the delayed updated state information can be written back into memory at the designated storage address (not shown), where it will eventually be overwritten by the next updated state information.

A specific embodiment of the invention which demonstrates the principles involved will now be described. In this embodiment, the memory array comprises storage means holding the state of an array of count registers (or counters). The counters are updated by processing an incoming stream of informational elements, where each informational element functions on a specified counter.

Each group to which an informational element belongs corresponds to a particular counter. Each counter has a separate storage address and each informational element can be considered a function to be performed on the value currently held in the storage address for a count register.

FIGS. 7A, 7B, and 7C show embodiments of the invention in which the method is utilized.

The scope of the invention is considered not to be limited by the above description but is to be determined by the accompanying claims.

The text of the abstract repeated herein below is hereby deemed incorporated into the description.

A combinatorial processor capable of processing a plurality of groups of informational elements is provided in which each group has at least one distinguishing characteristic. The combinatorial processor comprises a time-division multiplexed combinatorial logic element; and a plurality of storage elements. Each storage element is associated with one of the plurality of groups, and within a time-slot of the time-dimension multiplexed combinatorial logic element a storage element stores state information in accordance with information processed from one of the informational elements of the group associated with that storage element. The invention thus enables read state information for an informational element currently being processed to be replaced with the write state information from a previous informational element in the case where two informational elements belonging to the same group are adjacent to each other in the sequence.

As an example, consider the case where, for example, the second counter in the array of counters has a value of 25. A first informational element extracted from the inputted data stream consists of a command to increment by one the value which held at the storage address for the second counter. This informational element is then processed with the current state information for the second counter, ie., the value currently held which is 25. This results in the processed state being 26. As the processing takes a finite amount of time, there is a possibility that a subsequent informational element functioning on the same counter could be received, in which case, this informational element will function on the current value held at the storage address for the second counter which has not yet been updated. For example, if the next informational element received the command to update the current value stored at the storage address for the second counter by the value 2, this next informational element will act on the value 25, and update this in error to 27, instead on acting on the value 26 which should have been updated to 28.

The invention enables the processed value 26 to be used instead by enabling inputted information to be combined with the currently processed state. This is achieved by means of a “cut-through” mechanism. If the read address of the informational element currently being processed is the same as the write address of a previously processed element, the actual value currently stored in the storage element is bypassed and the information used by the combinatorial logic upon which the input informational element functions is the value produced by the processing of the previous information element. If the read address is not the same as the write address, the information used by the combinatorial logic is the previous state read from the storage element using the read address.

1. A combinatorial processor capable of processing a plurality of groups of informational elements, each group having at least one distinguishing characteristic, the combinatorial processor having:
a time-division multiplexed combinatorial logic element; and
a plurality of storage elements, wherein
each storage element is associated with one of the plurality of groups, and wherein within a time-slot of the time-division multiplexed combinatorial logic element, a storage element stores state information in accordance with information processed from one of the informational elements of the group associated with that storage element.

2. A processor as claimed in claim 1, wherein each storage element stores the state of the informational group to act as a virtual finite state machine.

3. A processor as claimed in claim 1, wherein the combinatorial logic generates the read address for the state information, from which the write address is also generated using delay elements.

4. A processor as claimed in claim 1, wherein the read address for the state information comprises a write address generated using delay elements, wherein state information generated by the processing of a previous informational element is held at the write address.

5. A processor as claimed in claim 1, wherein the combinatorial processor is able to function as a plurality of finite state machines by duplicating state storage functions internally.

6. A processor as claimed in claim 1, wherein said storage elements comprise a register file.

7. A processor as claimed in claim 1, wherein said storage elements comprise Random Access Memory.

8. A processor as claimed in claim 1, wherein the combinatorial processor determines the next state of any one of the plurality of groups of informational elements in accordance with the current state and any input received.

9. A processor as claimed in claim 1, wherein the informational elements of each group are interleaved.

10. A processor as claimed in claim 1, wherein the informational elements of each group are interleaved and the interleaved sequence of informational elements is read in sequence.

11. A processor as claimed in claim 1, wherein the time-slots of the time-division multiplexing process are variable in length.

12. A combinatorial processor capable of processing a plurality of groups of informational elements, each group having at least one distinguishing characteristic, the combinatorial processor having:
a time-division multiplexed combinatorial logic element; and
a plurality of storage elements, wherein
each storage element is associated with one of the plurality of groups, and wherein within a time-slot of the time-division Multiplexed combinatorial logic element, a storage element stores state information in accordance with information processed from one of the informational elements of the group associated with that storage element, wherein the write address of previously generated state information is used as the read address for state information to be processed by a subsequently input informational element by using a delay elements in the event that the previously generated state information was generated by an informational element belonging to the same group as the subsequently input informational element.

13. A method of processing a plurality of groups of informational elements, each group having at least one distinguishing characteristic, the method comprising:
receiving an informational element;
extracting information from the informational element and determining state information in accordance with the extracted information using a time-division multiplexed combinatorial logic element; selecting a storage element in accordance with the group of the informational element; and
storing the said state information in the storage element.

14. A method as claimed in claim 13, wherein said step of storing the said state information further comprises the steps of:
creating a write address for storing the written state information corresponding to a read address for a state information of a subsequent second informational element by using a delay element in the case where the two informational elements belong to the same group.

15. A method as claimed in claim 131 wherein the delay element comprises a flip-flop.

16. A method as claimed in claim 13, wherein the informational elements are interleaved to from a sequence having a regular pattern.

17. A time-division multiplexed finite state machine having a combinatorial processor capable of processing a plurality of groups of informational elements, each group having at least one distinguishing characteristic, the combinatorial processor having:
a time-division multiplexed combinatorial logic element; and
a plurality of storage elements, wherein
each storage element is associated with one of the plurality of groups, and wherein within a time-slot of the time-division multiplexed combinatorial logic element, a storage element stores state information in accordance with information processed from one of the informational elements of the group associated with that storage element.

18. A time-division multiplexed finite state machine as claimed in claim 17, wherein the finite state machine is used to determine information on a plurality of lower order data streams within a higher order virtual container.

19. A finite state machine as claimed in claim 17, wherein the finite state machine is a counter-like machine for counting at least one characteristic of the informational elements.

20. A finite state machine as claimed in claim 17, wherein the finite state machine is be used to identify any of a number of characteristics relating to the information elements within an information group or a subset thereof.

21. Apparatus for a communications network having a time-division multiplexed finite state machine having a combinatorial processor capable of processing a plurality of groups of informational elements, each group having at least one distinguishing characteristic, the combinatorial processor having:
a time-division multiplexed combinatorial logic element; and
a plurality of storage elements, wherein
each storage element is associated with one of the plurality of groups, and wherein within a time-slot of the time-division multiplexed combinatorial logic element, a storage element stores state information in accordance with information processed from one of the informational elements of the group associated with that storage element.

22. A method of extracting state information from a storage element maintaining the state of a plurality of time-division multiplexed data streams, wherein each data stream comprises a group of informational elements, each data stream having at least one distinguishing characteristic, the method comprising:
receiving an informational element;
extracting information from the informational element and determining state information in accordance with the extracted information using a time-division multiplexed logic element;
selecting a storage element in accordance with the data stream of the informational element; and
storing the said state information in the storage element.

23. A method of pointer processing using a combinatorial processor according to the first aspect of the invention and employing a method according to claim 22.

24. A method of path overhead processing using a combinatorial processor according to claim 1, and employing a method according to claim 17.

25. A clocking function for generating state information on an informational element in a sequence of interleaved groups of informational elements, each group of informational elements having at least one distinguishing characteristic, wherein the clocking function is provided to replace the read state information for the current element with the write state information from the previous element in the case where two informational elements belonging to the same group are adjacent to each other in the sequence.

26. A docking function as claimed in claim 25, wherein the clocking function is implemented by a combinatorial processor according to claim 1.

27. A clocking function as claimed in claim 26, wherein the clocking function does not require any additional memory control, and enables data in adjacent time-slots to be accessed without delay.
